(19) United States
(12) Patent Application Publication
(10) Pub. No.: US 2024/0234894 A9
(43) Pub. Date: Jul. 11, 2024

(54) BATTERY MODULE

(71) Applicant: Prime Planet Energy & Solutions, Inc., Tokyo (JP)

(72) Inventors: Shota HIROHATA, Kasai-shi (JP); Iwao TANAKA, Osaka (JP); Kosyo ABE, Himeji-shi (JP); Yoshiko DAIJO, Himeji-shi (JP)

(21) Appl. No.: 18/490,702

(22) Filed: Oct. 19, 2023

(30) Foreign Application Priority Data
Oct. 20, 2022 (JP) 2022-168084

(51) Int. Cl. H01M 50/238; H01M 50/209; H01M 50/278; H01M 50/507

(52) U.S. Cl. CPC H01M 50/238; H01M 50/209; H01M 50/278; H01M 50/507

(57) ABSTRACT

A cover body has: a plurality of divided cover portions arranged side by side in a Y axis direction; an elastic deformation portion extending between the divided cover portions adjacent to each other; a first connection portion provided in a first divided cover portion disposed at one end portion in the Y axis direction, the first connection portion being connected to the attachment-target member so as to be fixed in the Y axis direction; a second connection portion provided in a second divided cover portion disposed at the other end portion in the Y axis direction, the second connection portion being connected to the attachment-target member so as to be fixed in the Y axis direction; and a third connection portion disposed between the first connection portion and the second connection portion and connected to the attachment-target member so as to be slidable in the Y axis direction.

### CROSS REFERENCE TO RELATED APPLICATIONS

This nonprovisional application is based on Japanese Patent Application No. 2022-168084 filed on Oct. 20, 2022 with the Japan Patent Office, the entire contents of which are hereby incorporated by reference.

### BACKGROUND OF THE INVENTION

### Field of the Invention

The present invention relates to a battery module.

### Description of the Background Art

For example, Japanese Patent Laying-Open No. 2013-157128 discloses a power supply device including: a case main body disposed on the electrode side of a battery assembly and having a plurality of terminal fixing portions coupled together via a hinge portion; and a cover fixed to the case body and covering the plurality of terminal fixing portions. The cover has two divided cover portions and a hinge portion coupling the divided cover portions together.

Further, Japanese Patent Laying-Open No. 2014-229594 discloses a bus bar module including: a bus bar case that accommodates a bus bar; three insulating covers that cover an opening of the bus bar case; and a coupling member that has flexibility and that couples adjacent insulating covers together.

Further, Japanese Patent Laying-Open No. 2018-181562 discloses a battery wiring module including: a first divided housing and a second divided housing each attached to an upper portion of a secondary battery; a first cover and a second cover that respectively cover openings of the first divided housing and the second divided housing; and a tongue piece portion extending from the first cover toward the second cover.

### SUMMARY OF THE INVENTION

As disclosed in Japanese Patent Laying-Open No. 2013-157128, there has been known a battery module including: a plurality of battery cells (battery assembly) stacked in one direction; and a cover body attached to an attachment-target member (case body) and provided to cover the plurality of battery cells.

In such a battery module, when a temperature of a case body is changed due to a temperature change of a battery cell, the cover body is expanded or contracted in accordance with its linear expansion coefficient. In this case, the position of the cover body may be displaced with respect to the plurality of battery cells or an excessive stress may act on a connection portion of the cover body to the attachment-target member, thereby compromising a state of attachment of the cover body.

Thus, it is an object of the present invention to solve the above-mentioned problem and to provide a battery module to more securely maintain a state of attachment of a cover body while preventing positional displacement of the cover body with respect to a plurality of battery cells.

[1] A battery module comprising: a plurality of stacked battery cells; a cover body provided to cover the plurality of battery cells; and an attachment-target member to which the cover body is attached, wherein the cover body has a plurality of divided cover portions arranged side by side with a clearance being provided between the plurality of divided cover portions in a first direction, the plurality of divided cover portions being divided from each other, an elastic deformation portion extending between the divided cover portions adjacent to each other in the first direction, the elastic deformation portion being elastically deformable to change a size of the clearance, a first connection portion provided in a first divided cover portion of the plurality of divided cover portions, the first divided cover portion being disposed at one end portion in the first direction, the first connection portion being connected to the attachment-target member so as to be fixed in the first direction, a second connection portion provided in a second divided cover portion of the plurality of divided cover portions, the second divided cover portion being disposed at the other end portion in the first direction, the second connection portion being connected to the attachment-target member so as to be fixed in the first direction, and a third connection portion provided in each of the divided cover portions, the third connection portion being disposed between the first connection portion and the second connection portion in the first direction, the third connection portion being connected to the attachment-target member so as to be slidable in the first direction.

According to the battery module thus configured, in response to expansion and contraction of the cover body due to a temperature change, the elastic deformation portion is elastically deformed to change the size of the clearance between the divided cover portions adjacent to each other in the first direction. In this case, since each of the first connection portion and the second connection portion is connected to the attachment-target member so as to be fixed in the first direction and the third connection portion disposed between the first connection portion and the second connection portion is connected to the attachment-target member so as to be slidable in the first direction, a sliding movement of the cover body along the first direction in response to the expansion and contraction of the cover body is permitted while the positions of the first divided cover portion and the second divided cover portion are kept at both ends in the first direction. Thus, the state of attachment of the cover body can be more securely maintained while preventing positional displacement of the cover body with respect to the plurality of battery cells.

[2] The battery module according to [1], wherein the first divided cover portion is further provided with the third connection portion, the second divided cover portion is further provided with the third connection portion, and a third divided cover portion of the plurality of divided cover portions is provided with a plurality of the third connection portions, the third divided cover portion being disposed between the first divided cover portion and the second divided cover portion in the first direction.

According to the battery module thus configured, the sliding movement of each of the first divided cover portion, the second divided cover portion, and the third divided cover portion along the first direction can be permitted while the positions of the first divided cover portion and the second divided cover portion are kept at the both ends in the first direction.

[3] The battery module according to [1] or [2], wherein the elastic deformation portion extends while being curved between the divided cover portions adjacent to each other in the first direction.

According to the battery module thus configured, an excessive stress can be suppressed from being generated in the elastic deformation portion that is elastically deformed in response to expansion and contraction of the cover body.

[4] The battery module according to any one of [1] to [3], wherein the plurality of battery cells are stacked in the first direction, the plurality of divided cover portions face the plurality of battery cells in a second direction orthogonal to the first direction, and the elastic deformation portion is provided to project from each of the divided cover portions in a third direction orthogonal to the first direction and the second direction.

According to the battery module thus configured, the size of the battery module can be prevented from being large in each of the first direction and the second direction due to the provision of the elastic deformation portion.

[5] The battery module according to any one of [1] to [4], wherein the cover body is formed in one piece using a resin material.

According to the battery module thus configured, the cover body can be constructed in a simple manner.

[6] The battery module according to any one of [1] to [5], wherein the plurality of battery cells are stacked in the first direction, and the plurality of divided cover portions face the plurality of battery cells in a second direction orthogonal to the first direction, the battery module further comprising a plurality of battery cell units arranged side by side in the first direction, wherein each of the battery cell units has a plurality of the battery cells arranged side by side continuously in the first direction, and a case body that accommodates the plurality of the battery cells arranged side by side continuously in the first direction, and the clearance extends along a boundary between the case bodies adjacent to each other in the first direction when viewed in the second direction.

According to the battery module thus configured, an insulation distance between the clearance and each battery cell can be set to be large.

[7] The battery module according to [6], further comprising: a bus bar that is connected to the battery cells and that electrically connects the battery cells adjacent to each other in the first direction; and a tab terminal connected to the bus bar and facing the cover body in the second direction, wherein each of the divided cover portions further has a protrusion protruding, in a direction toward the battery cells in the second direction, from an edge portion of the divided cover portion forming the clearance, the protrusion being provided along the tab terminal when viewed in the second direction.

According to the battery module thus configured, an insulation distance between the clearance and the tab terminal can be set to be large.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery module according to an embodiment of the present invention.

FIG. 2 is another perspective view showing the battery module according to the embodiment of the present invention.

FIG. 3 is an exploded assembly diagram showing the battery module in FIG. 1.

FIG. 4 is a perspective view showing an internal structure of the battery module in FIG. 1.

FIG. 5 is another perspective view showing the internal structure of the battery module in FIG. 1.

FIG. 6 is a perspective view showing a battery cell unit included in the battery module in FIG. 1.

FIG. 7 is a perspective view showing a battery cell included in the battery cell unit in FIG. 1.

FIG. 8 is a perspective view showing a cover body.

FIG. 9 is another perspective view showing the cover body.

FIG. 10 is an enlarged perspective view of a region surrounded by a chain double-dashed line X in FIG. 8.

FIG. 11 is a top view partially showing the battery module in FIG. 1.

FIG. 12 is a cross sectional view showing the battery module when viewed in a direction of arrow on a line XII-XII in FIG. 11.

FIG. 13 is a cross sectional view showing the battery module when viewed in a direction of arrow on a line XIII-XIII in FIG. 11.

### DESCRIPTION OF THE PREFERRED EMBODIMENTS

Embodiments of the present invention will be described with reference to figures. It should be noted that in the figures referred to below, the same or corresponding members are denoted by the same reference characters.

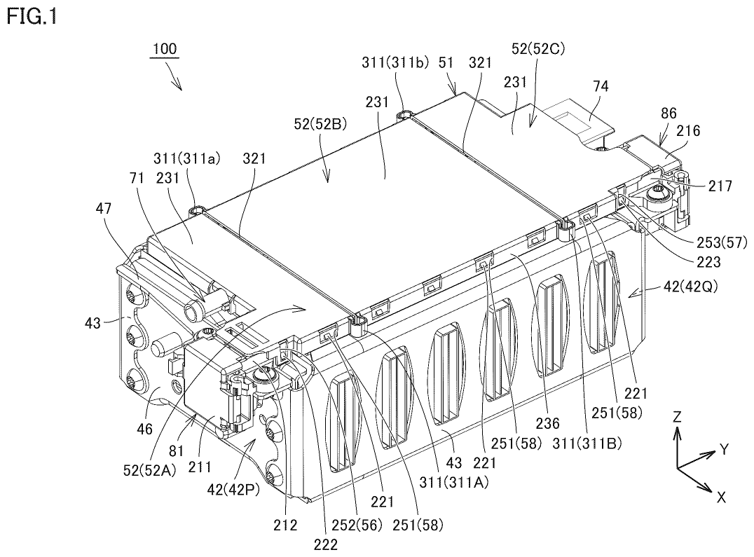

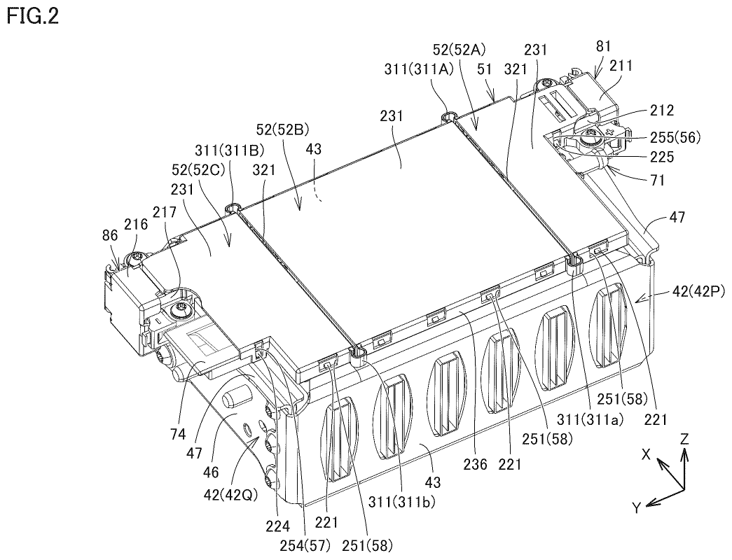

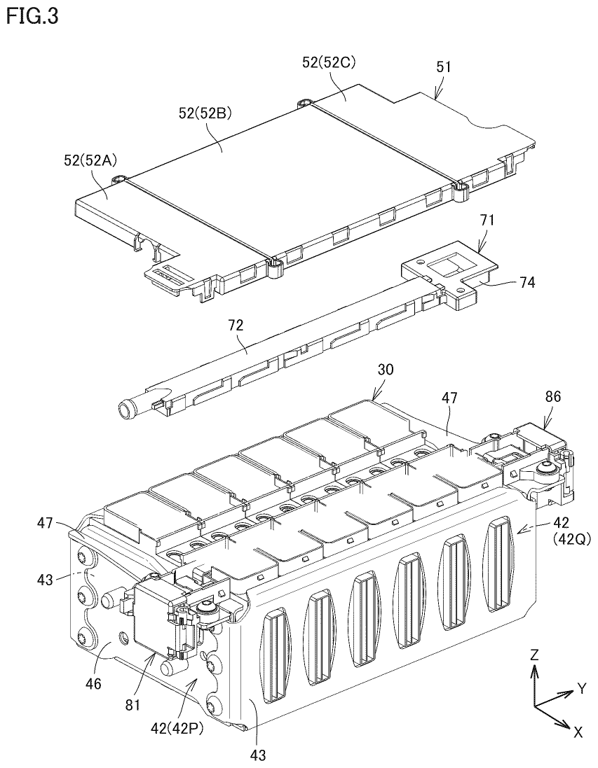

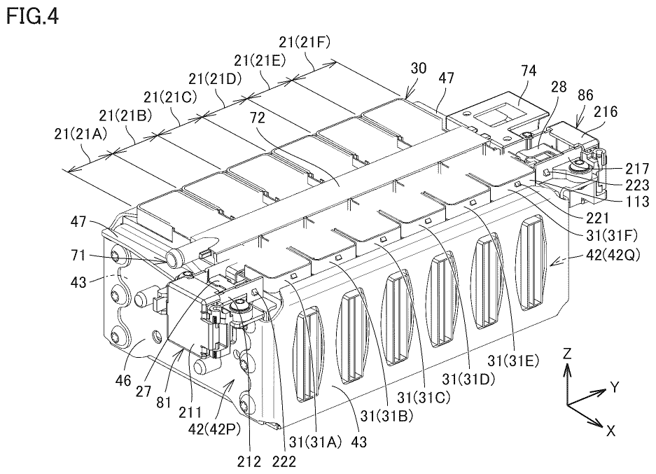

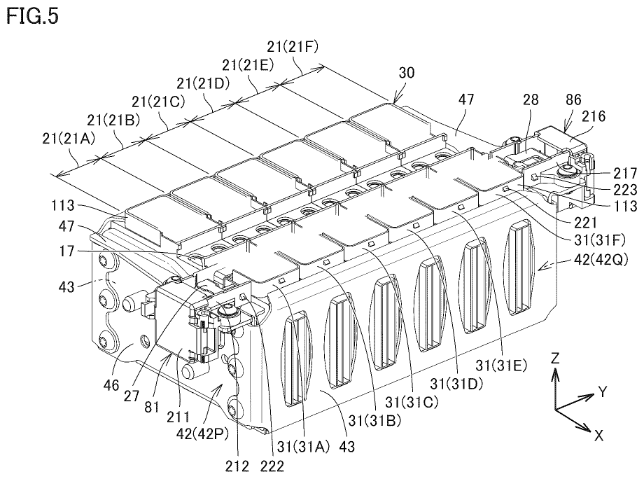

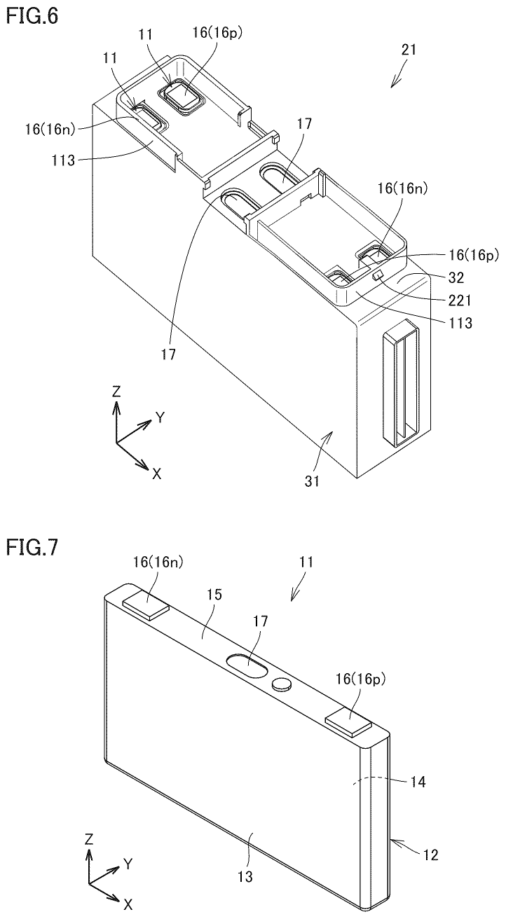

Each of FIGS. 1 and 2 is a perspective view showing a battery module according to an embodiment of the present invention. FIG. 3 is an exploded assembly diagram showing the battery module in FIG. 1. Each of FIGS. 4 and 5 is a perspective view showing an internal structure of the battery module in FIG. 1. FIG. 6 is a perspective view showing a battery cell unit included in the battery module in FIG. 1. FIG. 7 is a perspective view showing a battery cell included in the battery cell unit in FIG. 1.

Referring to FIGS. 1 to 7, a battery module 100 is used as a power supply for driving a vehicle such as a hybrid electric vehicle (HEV), a plug-in hybrid electric vehicle (PHEV), or a battery electric vehicle (BEV).

In the present specification, for convenience of description of the structure of battery module 100, the “Y axis” represents an axis extending in parallel with a stacking direction of a plurality of below-described battery cells 11, the “X axis” represents an axis extending in a direction orthogonal to the Y axis, and the “Z axis” represents an axis extending in a direction orthogonal to the Y axis and the X axis. An obliquely rightward upward direction in the plane of sheet of FIG. 1 is “+Y axis direction”, and an obliquely leftward downward direction in the plane of sheet of FIG. 1 is “−Y axis direction”. An obliquely rightward downward direction in the plane of sheet of FIG. 1 is “+X axis direction” and an obliquely leftward upward direction in the plane of sheet of FIG. 1 is “−X axis direction”. An upward direction in the plane of sheet of FIG. 1 is “+Z axis direction” and a downward direction in the plane of sheet of FIG. 1 is “−Z axis direction”. Typically, battery module 100 is mounted on a vehicle in such a posture that the +Z axis direction corresponds to the upward direction and the −Z axis direction corresponds to the downward direction.

First, an overall structure of battery module 100 will be described. As shown in FIGS. 4 and 5, battery module 100 has a plurality of battery cell units 21 (21A, 21B, 21C, 21D, 21E, 21F).

The plurality of battery cell units 21 are arranged side by side in the Y axis direction. Battery cell unit 21A, battery cell unit 21B, battery cell unit 21C, battery cell unit 21D, battery cell unit 21E, and battery cell unit 21F are arranged side by side in this order from the negative side to the positive side in the Y axis direction. It should be noted that the number of battery cell units 21 included in battery module 100 is not particularly limited as long as two or more battery cell units 21 are included.

As shown in FIGS. 6 and 7, each of battery cell units 21, i.e., each of battery cell units 21A to 21F has a plurality of battery cells 11 and a case body 31.

In each battery cell unit 21, two battery cells 11 are arranged side by side continuously in the Y axis direction. It should be noted that the number of battery cells 11 included in each battery cell unit 21 is not particularly limited as long as a plurality of battery cells 11 are included.

Each of battery cells 11 is a lithium ion battery. Battery cell 11 has an output density of 8000 W/L or more. Battery cell 11 has a prismatic shape and has a thin plate shape in the form of a rectangular parallelepiped. The plurality of battery cells 11 are stacked such that the Y axis direction corresponds to the thickness direction of each battery cell 11.

Each of battery cells 11 has an exterior package 12. Exterior package 12 is constituted of a housing having a rectangular parallelepiped shape, and forms the external appearance of battery cell 11. An electrode assembly and an electrolyte solution are accommodated in exterior package 12.

Exterior package 12 has a cell side surface 13, a cell side surface 14, and a cell top surface 15. Each of cell side surface 13 and cell side surface 14 is constituted of a flat surface orthogonal to the Y axis direction. Cell side surface 13 and cell side surface 14 are oriented oppositely in the Y axis direction. Each of cell side surface 13 and cell side surface 14 has the largest area among the areas of the plurality of side surfaces of exterior package 12. Cell top surface 15 is constituted of a flat surface orthogonal to the Z axis direction. Cell top surface 15 is oriented in the +Z axis direction.

Battery cell 11 further has a gas-discharge valve 17. Gas-discharge valve 17 is provided in cell top surface 15. Gas-discharge valve 17 is provided at the center portion of cell top surface 15 in the X axis direction. When internal pressure of exterior package 12 becomes more than or equal to a predetermined value due to gas generated inside exterior package 12, gas-discharge valve 17 discharges the gas to the outside of exterior package 12. The gas from gas-discharge valve 17 flows through a below-described duct 71 and is discharged to the outside of battery module 100.

Battery cell 11 further has electrode terminals 16 that are a pair of a positive electrode terminal 16p and a negative electrode terminal 16n. Electrode terminals 16 are provided on cell top surface 15. Positive electrode terminal 16p and negative electrode terminal 16n are provided on both sides with gas-discharge valve 17 being interposed therebetween in the X axis direction.

Case body 31 has a rectangular parallelepiped appearance. Case body 31 is composed of a resin. In each battery cell unit 21, case body 31 accommodates a plurality of battery cells 11. Case body 31 has a case top portion 32. Case top portion 32 has a wall shape having a thickness direction corresponding to the Z axis direction with case top portion 32 being disposed in parallel with the X-Y axes plane.

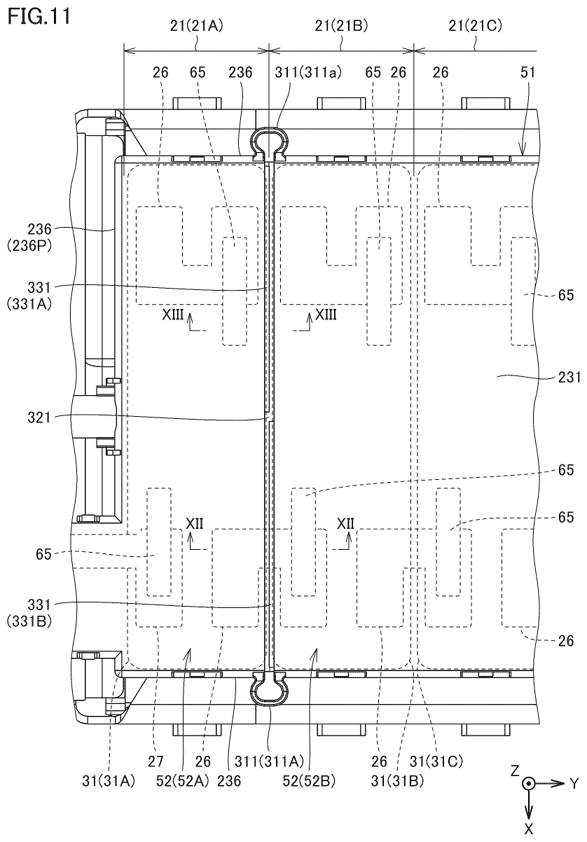

As shown in FIGS. 4 and 5, the plurality of battery cells 11 are stacked in the Y axis direction across battery cell units 21A to 21F arranged side by side in the Y axis direction. The plurality of battery cells 11 are stacked such that cell side surfaces 13 of battery cells 11 adjacent to each other in the Y axis direction face each other and cell side surfaces 14 of battery cells 11 adjacent to each other in the Y axis direction face each other. Thus, positive electrode terminals 16p and negative electrode terminals 16n are alternately arranged in the Y axis direction in which the plurality of battery cells 11 are stacked. Positive electrode terminal 16p and negative electrode terminal 16n adjacent to each other in the Y axis direction are connected to each other by a bus bar 26 (see FIG. 11 below). Thus, the plurality of battery cells 11 are electrically connected together in series.

As shown in FIGS. 1 to 5, battery module 100 further has a pair of end plates 42 (42P, 42Q) and a pair of binding bars 43. The pair of binding bars 43 and the pair of end plates 42 collectively hold the plurality of battery cell units 21 (the plurality of battery cells 11) arranged side by side in the Y axis direction.

The pair of end plates 42 are disposed at both ends beside the plurality of battery cells 11 (the plurality of battery cell units 21) in the Y axis direction. End plate 42P faces battery cell unit 21A in the Y axis direction, and end plate 42Q faces battery cell unit 21F in the Y axis direction.

Each of end plates 42 has a plate portion 46 and a roof portion 47. Plate portion 46 has a plate shape having a thickness direction corresponding to the Y axis direction. Roof portion 47 extends, from an end portion (upper end portion) of plate portion 46 in the +Z axis direction, in a direction away from the stack of battery cells 11 in the Y axis direction. Roof portion 47 has a roof shape having a thickness in the Z axis direction and extending in the form of a strip along the upper end portion of plate portion 46.

The pair of binding bars 43 are disposed at both ends of the stack of battery cells 11 in the X axis direction. Each of binding bars 43 extends in the Y axis direction. An end portion of binding bar 43 in the −Y axis direction is connected to end plate 42P. An end portion of binding bar 43 in the +Y axis direction is connected to end plate 42Q. The pair of binding bars 43 and the pair of end plates 42 apply a restraint force in the Y axis direction onto the plurality of battery cells 11 (the plurality of battery cell units 21).

Battery module 100 further has a positive terminal box 81 and a negative terminal box 86. Each of positive terminal box 81 and negative terminal box 86 is composed of a resin. Positive terminal box 81 and negative terminal box 86 respectively accommodate a positive collective terminal and a negative collective terminal each for connecting battery module 100 to an external wiring such as a cable disposed outside battery module 100.

Positive terminal box 81 has a base 212 and an openable/closable door 211. Base 212 is attached to end plate 42 (42P). Base 212 is provided over roof portion 47 in the Y axis direction. A bus bar 27 extending from battery cell 11 toward the positive collective terminal is mounted on base 212. Openable/closable door 211 is attached to base 212 so as to be openable and closable. Negative terminal box 86 has a base 217 and an openable/closable door 216. Base 217 and openable/closable door 216 correspond to base 212 and openable/closable door 211 in positive terminal box 81, respectively. A bus bar 28 extending from battery cell 11 toward the negative collective terminal is mounted on base 217.

Battery module 100 further has duct 71 and a cover body 51. Duct 71 is composed of a resin. Duct 71 extends in the Y axis direction with duct 71 facing the plurality of battery cells 11 (the plurality of battery cell units 21) in the Z axis direction. Duct 71 forms a path through which gas discharged from each of the plurality of battery cells 11 flows. Duct 71 is attached to a plurality of case bodies 31.

As shown in FIG. 3, duct 71 has a duct main body portion 72 and a connector supporting portion 74. Duct main body portion 72 forms a main part of duct 71 for allowing gas from each battery cell 11 to flow therethrough. Duct main body portion 72 extends in the Y axis direction with duct main body portion 72 facing, in the Z axis direction, the plurality of gas-discharge valves 17 arranged side by side with a space being interposed therebetween in the Y axis direction. Connector supporting portion 74 extends in the +Y axis direction from the end portion of duct main body portion 72 in the +Y axis direction. Connector supporting portion 74 has a shape of plate disposed in parallel with the X-Y axes plane.

Cover body 51 is composed of a resin. Cover body 51 is provided to cover the plurality of battery cells 11 in the Z axis direction. Cover body 51 is provided to face case top portions 32 of case bodies 31 in the Z axis direction. Cover body 51 is provided to further cover bus bars 26, 27, 28 and duct 71.

Cover body 51 is detachably attached to the plurality of case bodies 31, base 212, base 217, and duct 71. The plurality of case bodies 31, base 212, base 217, and duct 71 constitute an attachment-target member 30 to which cover body 51 is attached.

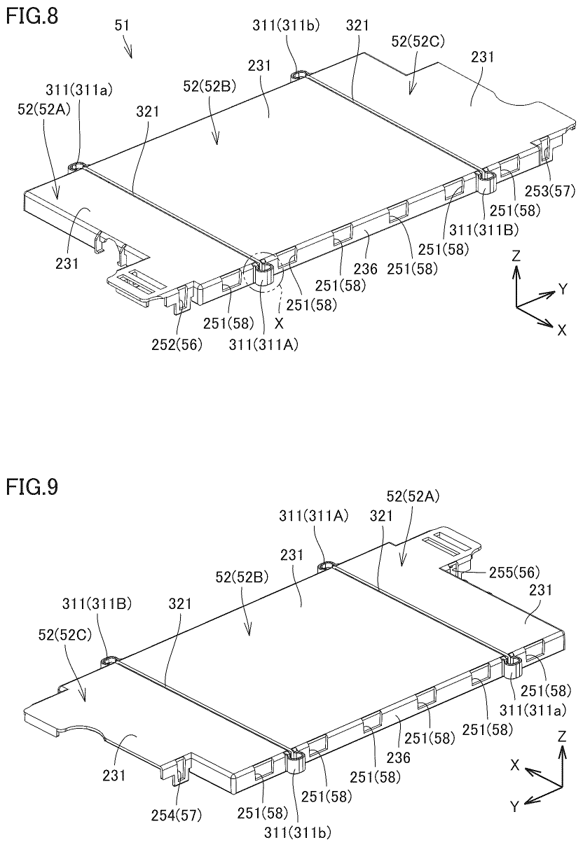

Each of FIGS. 8 and 9 is a perspective view showing the cover body. Next, a structure of cover body 51 will be described more specifically.

Referring to FIGS. 1 to 5 as well as FIGS. 8 and 9, cover body 51 has a flat plate portion 231 and edge portions 236. Flat plate portion 231 has a thickness in the Z axis direction and is disposed in parallel with the X-Y axes plane orthogonal to the Z axis direction. Flat plate portion 231 has a quadrangular shape as a whole when viewed in a plan view. Flat plate portion 231 is provided to face the plurality of battery cells 11 (the plurality of battery cell units 21) in the Z axis direction. Each of edge portions 236 extends in the −Z axis direction from a peripheral edge portion of flat plate portion 231. Edge portion 236 has a height in the Z axis direction and intermittently extends along the peripheral edge portion of flat plate portion 231.

Cover body 51 has a plurality of divided cover portions 52 and a plurality of elastic deformation portions 311. The plurality of divided cover portions 52 are divided from each other. The plurality of divided cover portions 52 are arranged side by side with a clearance 321 being provided therebetween in the Y axis direction. Clearance 321 has a slit shape extending in the X axis direction and having a width in the Y axis direction.

The plurality of divided cover portions 52 include a first divided cover portion 52A, a second divided cover portion 52C, and a third divided cover portion 52B. First divided cover portion 52A of the plurality of divided cover portions 52 arranged side by side in the Y axis direction is disposed at an end portion in the −Y axis direction. Second divided cover portion 52C of the plurality of divided cover portions 52 arranged side by side in the Y axis direction is disposed at an end portion in the +Y axis direction. Third divided cover portion 52B is disposed between first divided cover portion 52A and second divided cover portion 52C in the Y axis direction.

The length of each of first divided cover portion 52A and second divided cover portion 52C in the Y axis direction is smaller than the length of third divided cover portion 52B in the Y axis direction.

In the present embodiment, it has been described that clearance 321 between divided cover portions 52 extends in the direction (X axis direction) orthogonal to the stacking direction (Y axis direction) of battery cells 11; however, clearance 321 may extend in any direction in the X-Y axes plane. Clearance 321 may be constituted of a combination of a plurality of segments extending in different directions (for example, a combination of a segment extending in the X axis direction, a segment extending in the Y axis direction, and a segment extending in the X axis direction). The cover body according to the present invention may have two divided cover portions or four or more divided cover portions.

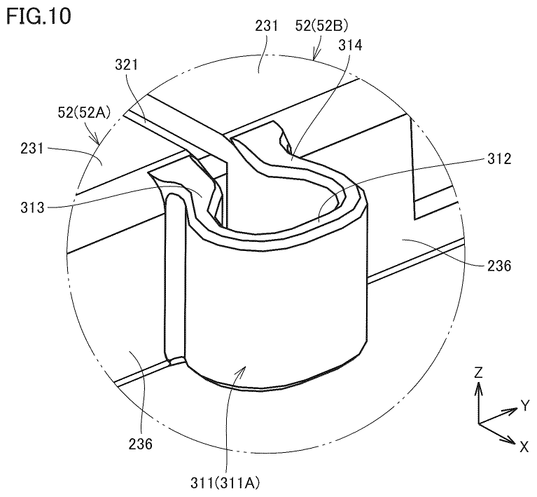

FIG. 10 is an enlarged perspective view of a region surrounded by a chain double-dashed line X in FIG. 8. Referring to FIGS. 8 to 10, each elastic deformation portion 311 extends between divided cover portions 52 adjacent to each other in the Y axis direction.

The plurality of elastic deformation portions 311 include a first elastic deformation portion 311A, a second elastic deformation portion 311a, a third elastic deformation portion 3111B, and a fourth elastic deformation portion 311b. Each of first elastic deformation portion 311A and second elastic deformation portion 311a extends between first divided cover portion 52A and third divided cover portion 52B. First elastic deformation portion 311A and second elastic deformation portion 311a are symmetrically provided on both sides with respect to the center line of cover body 51 extending in the Y axis direction. Each of third elastic deformation portion 311B and fourth elastic deformation portion 311b extends between third divided cover portion 52B and second divided cover portion 52C. Third elastic deformation portion 311B and fourth elastic deformation portion 311b are symmetrically provided on both sides with respect to the center line of cover body 51 extending in the Y axis direction.

Each of elastic deformation portions 311 is elastically deformable to change the size of clearance 321. Elastic deformation portion 311 is elastically deformable to change the length of clearance 321 in the Y axis direction. Elastic deformation portion 311 is provided in one piece with the plurality of divided cover portions 52 using a resin material. Cover body 51 is formed in one piece using a resin material. According to such a configuration, since cover body 51 is constituted of a single component, manufacturing cost of battery module 100 can be reduced.

Referring to first elastic deformation portion 311A shown in FIG. 10, first elastic deformation portion 311A extends while being curved between first divided cover portion 52A and third divided cover portion 52B. First elastic deformation portion 311A has an unchanged length (the same length as edge portion 236) in the Z axis direction. First elastic deformation portion 311A is provided to project in the +X axis direction from each of divided cover portions 52 (first divided cover portion 52A and third divided cover portion 52B). First elastic deformation portion 311A is provided at a position overlapping with binding bar 43 when viewed in the Z axis direction.

First elastic deformation portion 311A has a first base end portion 313, a second base end portion 314, and an intermediate portion 312. First base end portion 313 is connected to edge portion 236 of first divided cover portion 52A. Second base end portion 314 is connected to edge portion 236 of third divided cover portion 52B. Intermediate portion 312 extends in the form of an ellipse between first base end portion 313 and second base end portion 314. Intermediate portion 312 is provided to project from each of first base end portion 313 and second base end portion 314 in the +X axis direction and the ±Y axis direction. When first elastic deformation portion 311A is viewed in the Z axis direction, the width of each of first base end portion 313 and second base end portion 314 is larger than the width of intermediate portion 312.

In response to expansion and contraction of cover body 51, first elastic deformation portion 311A is elastically deformed to change a curvature of intermediate portion 312. In the present embodiment, since first elastic deformation portion 311A has a curved shape, an excessive stress can be suppressed from being generated locally in first elastic deformation portion 311A that is elastically deformed. Further, since first elastic deformation portion 311A is provided to project from each of divided cover portions 52 in the +X axis direction, the length (total height) of battery module 100 in the Z axis direction does not become large due to the provision of first elastic deformation portion 311A.

It should be noted that the configuration of first elastic deformation portion 311A has been representatively described herein; however, each of second elastic deformation portion 311a, third elastic deformation portion 311B, and fourth elastic deformation portion 311b has the same configuration as that of first elastic deformation portion 311A. The shape of each elastic deformation portion 311 is not particularly limited, and elastic deformation portion 311 may extend in the form of, for example, a U shape or triangular shape when viewed in the Z axis direction.

Next, a structure for attaching cover body 51 to attachment-target member 30 will be described. Referring to FIGS. 1 and 2 as well as FIGS. 8 and 9, cover body 51 further has first connection portions 56, second connection portions 57, and third connection portions 58.

Each of first connection portions 56 is provided in first divided cover portion 52A. First connection portion 56 is connected to attachment-target member 30 so as to be fixed in the Y axis direction. Each of second connection portions 57 is provided in second divided cover portion 52C. Second connection portion 57 is connected to attachment-target member 30 so as to be fixed in the Y axis direction. Third connection portions 58 are provided in divided cover portions 52 (first divided cover portion 52A, second divided cover portion 52C, and third divided cover portion 52B). Each of third connection portions 58 is disposed between first connection portion 56 and second connection portion 57 in the Y axis direction. Each of third connection portions 58 is connected to attachment-target member 30 so as to be slidable in the Y axis direction.

In FIGS. 4 and 5, respective case bodies 31 of battery cell unit 21A, battery cell unit 21B, battery cell unit 21C, battery cell unit 21D, battery cell unit 21E, and battery cell unit 21F are shown as a case body 31A, a case body 31B, a case body 31C, a case body 31D, a case body 31E, and a case body 31F, respectively. Referring to FIGS. 1 to 6, each of case bodies 31 further has rib portions 113 and claw portions 221.

Each of rib portions 113 extends in the form of a rib so as to protrude from case top portion 32 and surround electrode terminals 16 with rib portion 113 having a height in the Z axis direction. Each of claw portions 221 has a protruding shape protruding in the X axis direction from a side surface of a corresponding one of rib portions 113. Claw portions 221 are provided in an outer side surface of rib portion 113 oriented in the +X axis direction and an outer side surface of rib portion 113 oriented in the −X axis direction. Claw portion 221 has a protruding shape protruding in the +X axis direction in the outer surface of rib portion 113 oriented in the +X axis direction, and claw portion 221 has a protruding shape protruding in the −X axis direction in the outer surface of rib portion 113 oriented in the −X axis direction. In a state in which the plurality of case bodies 31 are arranged side by side in the Y axis direction, the plurality of claw portions 221 are provided with a space being interposed therebetween in the Y axis direction.

Referring to FIGS. 1 to 5, base 212 is provided with a claw portion 222 and a claw portion 225. Claw portion 222 is provided in an outer surface of base 212 oriented in the +X axis direction, and has a protruding shape protruding in the +X axis direction. Claw portion 225 is provided in an outer surface of base 212 oriented in the −X axis direction, and has a protruding shape protruding in the −X axis direction. Each of claw portion 222 and claw portion 225 is provided just above end plate 42P. Base 217 is provided with a claw portion 223. Claw portion 223 is provided in an outer surface of base 217 oriented in the +X axis direction, and has a protruding shape protruding in the +X axis direction. Claw portion 223 is provided just above end plate 42Q.

Connector supporting portion 74 of duct 71 is provided with a claw portion 224. Claw portion 224 is provided in an outer surface of connector supporting portion 74 oriented in the −X axis direction, and has a protruding shape protruding in the −X axis direction. Claw portion 224 is provided just above end plate 42Q.

Referring to FIGS. 1 to 5 as well as FIGS. 8 and 9, cover body 51 is provided with a plurality of openings 251, an opening 252, an opening 253, an opening 254, and an opening 255. The plurality of openings 251, opening 252, opening 253, opening 254 and opening 255 are provided in edge portion 236.

As shown in FIGS. 1 and 2, first divided cover portion 52A is provided with opening 252 and opening 255. Opening 252 and opening 255 are provided in a portion of first divided cover portion 52A that covers base 212. Claw portion 222 and claw portion 225 are fitted to opening 252 and opening 255, respectively. An opening length (width) of opening 252 in the Y axis direction is substantially the same as a length (width) of claw portion 222 in the Y axis direction, and an opening length (width) of opening 255 in the Y axis direction is substantially the same as a length (width) of claw portion 225 in the Y axis direction. Claw portion 222 and claw portion 225 are anchored inside opening 252 and opening 255, respectively, in the Z axis direction and the Y axis direction. With such a configuration, opening 252 and opening 255 constitute first connection portions 56 each connected to attachment-target member 30 (base 212) so as to be fixed in the Y axis direction.

Second divided cover portion 52C is provided with opening 253 and opening 254. Opening 253 is provided in a portion of second divided cover portion 52C that covers base 217. Opening 254 is provided in a portion of second divided cover portion 52C that covers connector supporting portion 74. Claw portion 223 and claw portion 224 are fitted to opening 253 and opening 254, respectively. An opening length (width) of opening 253 in the Y axis direction is substantially the same as a length (width) of claw portion 223 in the Y axis direction, and an opening length (width) of opening 254 in the Y axis direction is substantially the same as a length (width) of claw portion 224 in the Y axis direction. Claw portion 223 and claw portion 224 are anchored inside opening 253 and opening 254, respectively, in the Z axis direction and the Y axis direction. With such a configuration, opening 253 and opening 254 constitute second connection portions 57 each connected to attachment-target member 30 (base 217 and connector supporting portion 74) so as to be fixed in the Y axis direction.

First divided cover portion 52A is further provided with the plurality of openings 251. The plurality of openings 251 provided in first divided cover portion 52A are disposed between each of opening 252 and opening 255 and third divided cover portion 52B in the Y axis direction. Second divided cover portion 52C is further provided with the plurality of openings 251. The plurality of openings 251 provided in second divided cover portion 52C are disposed between each of opening 253 and opening 254 and third divided cover portion 52B in the Y axis direction. Third divided cover portion 52B is further provided with the plurality of openings 251. The plurality of openings 251 are disposed between each of opening 252 and opening 255 (first connection portion 56) and each of opening 253 and opening 254 (second connection portion 57) in the Y axis direction.

The plurality of claw portions 221 are fitted to the plurality of openings 251, respectively. An opening length (width) of each opening 251 in the Y axis direction is larger than a length (width) of each claw portion 221 in the Y axis direction. Claw portions 221 are disposed at positions away from the opening edges of openings 251 in the +Y axis directions. Claw portions 221 are anchored only in the Z axis direction inside openings 251. With such a configuration, the plurality of openings 251 constitute third connection portions 58 each connected to attachment-target member 30 (the plurality of case bodies 31) so as to be slidable in the Y axis direction.

Referring to FIGS. 1 and 2, in battery module 100 according to the present embodiment, in response to expansion of cover body 51 due to a temperature change, elastic deformation portions 311 are elastically deformed to decrease the size of clearance 321 between first divided cover portion 52A and third divided cover portion 52B and the size of clearance 321 between third divided cover portion 52B and second divided cover portion 52C, whereas similarly, in response to contraction of cover body 51, elastic deformation portions 311 are elastically deformed to increase the sizes of clearances 321. In this case, each of first connection portion 56 and second connection portion 57 is connected to attachment-target member 30 (base 212, base 217, and connector supporting portion 74) so as to be fixed in the Y axis direction, whereas third connection portion 58 disposed between first connection portion 56 and second connection portion 57 is connected to attachment-target member 30 (the plurality of case bodies 31) so as to be slidable in the Y axis direction. With such a configuration, a sliding movement of cover body 51 along the Y axis direction in response to expansion and contraction of cover body 51 is permitted while the positions of first divided cover portion 52A and second divided cover portion 52C are kept at the both ends in the Y axis direction. Thus, positional displacement of cover body 51 with respect to the plurality of battery cells 11 can be prevented, and deformation of cover body 51 or impairment of the state of attachment of cover body 51 to attachment-target member 30 can be prevented.

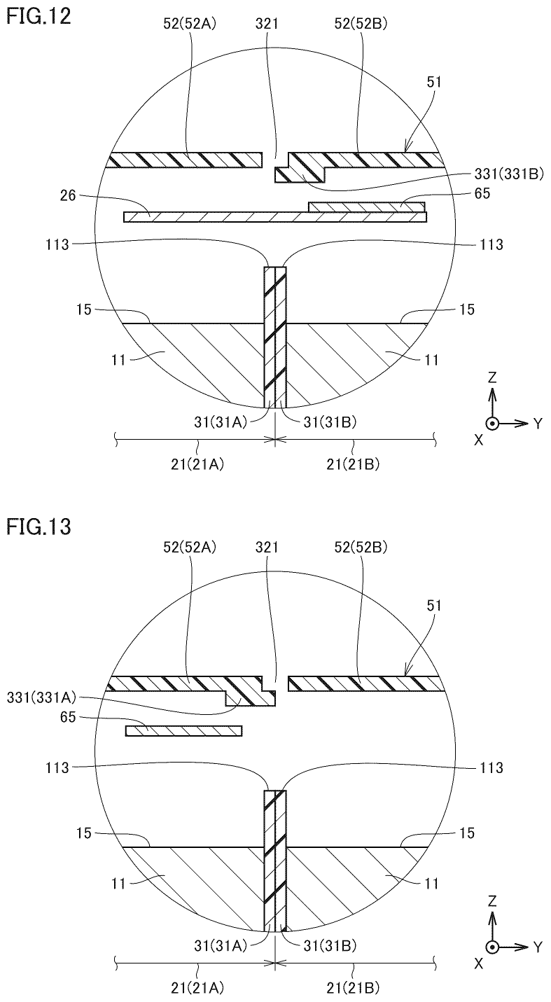

FIG. 11 is a top view partially showing the battery module in FIG. 1. FIG. 12 is a cross sectional view showing the battery module when viewed in a direction of arrow on a line XII-XII in FIG. 11. FIG. 13 is a cross sectional view showing the battery module when viewed in a direction of arrow on a line XIII-XIII in FIG. 11.

Referring to FIGS. 11 to 13, clearance 321 between first divided cover portion 52A and third divided cover portion 52B extends along a boundary between case body 31A and case body 31B adjacent to each other in the Y axis direction when viewed in the Z axis direction. Clearance 321 is disposed just above rib portions 113 of case bodies 31 that each protrude from case top portions 32 in the +Z axis direction and that each extend in the X axis direction.

According to such a configuration, an insulation distance between clearance 321 and battery cell 11 disposed close to clearance 321 can be set to be large.

Battery module 100 further has tab terminals 65. Tab terminals 65 are connected to bus bars 26. Each of tab terminals 65 faces cover body 51 in the Z axis direction. Tab terminals 65 are provided as terminals for detecting voltages of battery cells 11. Tab terminals 65 are connected to positive electrode terminals 16p of battery cells 11. Each of tab terminals 65 is provided at a position displaced in the X axis direction between battery cells 11 adjacent to each other in the Y axis direction. Tab terminal 65 is disposed between bus bar 26 and cover body 51 in the Z axis direction.

Divided cover portions 52 have protrusions 331 (331A, 331B). Each of protrusions 331 protrudes, in a direction (−Z axis direction) toward battery cells 11 in the Z axis direction, from the edge portion of divided cover portion 52 forming clearance 321. Protrusion 331 is provided along tab terminal 65 when viewed in the Z axis direction.

Protrusion 331A is provided in first divided cover portion 52A. When viewed in the Z axis direction, protrusion 331A is provided in a region on the negative side in the X axis direction with respect to the center line of cover body 51 extending in the Y axis direction. Protrusion 331A extends in a direction from first divided cover portion 52A toward third divided cover portion 52B, and extends in the X axis direction with an unchanged width in the Y axis direction. When viewed in the Z axis direction, protrusion 331A is provided along tab terminal 65 connected to bus bar 26 connecting battery cells 11 together in battery cell unit 21A. When viewed in the Z axis direction, protrusion 331A extends in the X axis direction at a position adjacent to tab terminal 65 in the Y axis direction.

Protrusion 331B is provided in third divided cover portion 52B. When viewed in the Z axis direction, protrusion 331B is provided in a region on the positive side in the X axis direction with respect to the center line of cover body 51 extending in the Y axis direction. Protrusion 331B extends in a direction from third divided cover portion 52B toward first divided cover portion 52A, and extends in the X axis direction with an unchanged width in the Y axis direction. When viewed in the Z axis direction, protrusion 331B is provided along tab terminal 65 connected to bus bar 26 connecting battery cells 11 together between battery cell unit 21A and battery cell unit 21B. When viewed in the Z axis direction, protrusion 331B extends in the X axis direction at a position adjacent to tab terminal 65 in the Y axis direction.

It should be noted that although not shown, a boundary portion between third divided cover portion 52B and second divided cover portion 52C has the same configuration as the boundary portion between first divided cover portion 52A and third divided cover portion 52B.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery module comprising:
a plurality of stacked battery cells;
a cover body provided to cover the plurality of battery cells; and
an attachment-target member to which the cover body is attached, wherein
the cover body has
a plurality of divided cover portions arranged side by side with a clearance being provided between the plurality of divided cover portions in a first direction, the plurality of divided cover portions being divided from each other,
an elastic deformation portion extending between the divided cover portions adjacent to each other in the first direction, the elastic deformation portion being elastically deformable to change a size of the clearance,
a first connection portion provided in a first divided cover portion of the plurality of divided cover portions, the first divided cover portion being disposed at one end portion in the first direction, the first connection portion being connected to the attachment-target member so as to be fixed in the first direction,
a second connection portion provided in a second divided cover portion of the plurality of divided cover portions, the second divided cover portion being disposed at the other end portion in the first direction, the second connection portion being connected to the attachment-target member so as to be fixed in the first direction, and
a third connection portion provided in each of the divided cover portions, the third connection portion being disposed between the first connection portion and the second connection portion in the first direction, the third connection portion being connected to the attachment-target member so as to be slidable in the first direction.

2. The battery module according to claim 1, wherein
the first divided cover portion is further provided with the third connection portion,
the second divided cover portion is further provided with the third connection portion, and
a third divided cover portion of the plurality of divided cover portions is provided with a plurality of the third connection portions, the third divided cover portion being disposed between the first divided cover portion and the second divided cover portion in the first direction.

3. The battery module according to claim 1, wherein the elastic deformation portion extends while being curved between the divided cover portions adjacent to each other in the first direction.

4. The battery module according to claim 1, wherein
the plurality of battery cells are stacked in the first direction,
the plurality of divided cover portions face the plurality of battery cells in a second direction orthogonal to the first direction, and
the elastic deformation portion is provided to project from each of the divided cover portions in a third direction orthogonal to the first direction and the second direction.

5. The battery module according to claim 1, wherein the cover body is formed in one piece using a resin material.

6. The battery module according to claim 1, wherein
the plurality of battery cells are stacked in the first direction, and
the plurality of divided cover portions face the plurality of battery cells in a second direction orthogonal to the first direction,
the battery module further comprising a plurality of battery cell units arranged side by side in the first direction, wherein
each of the battery cell units has
a plurality of the battery cells arranged side by side continuously in the first direction, and
a case body that accommodates the plurality of the battery cells arranged side by side continuously in the first direction, and
the clearance extends along a boundary between the case bodies adjacent to each other in the first direction when viewed in the second direction.

7. The battery module according to claim 6, further comprising:
a bus bar that is connected to the battery cells and that electrically connects the battery cells adjacent to each other in the first direction; and
a tab terminal connected to the bus bar and facing the cover body in the second direction, wherein
each of the divided cover portions further has a protrusion protruding, in a direction toward the battery cells in the second direction, from an edge portion of the divided cover portion forming the clearance, the protrusion being provided along the tab terminal when viewed in the second direction.
